(19) United States
(12) Patent Application Publication
(10) Pub. No.: US 2007/0056024 A1
(43) Pub. Date: Mar. 8, 2007

(54) METHOD FOR REMOTE SERVER LOGIN

(76) Inventors: Ho-Hsiung Hsu, Taipei County (TW); Chia-Lin Hsu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,276

(22) Filed: Sep. 5, 2005

(51) Int. Cl. H04L 9/32

(52) U.S. Cl. 726/5

(57) ABSTRACT

A method for remote server login is disclosed, in which the method using a second pathway for remote server login is adopted. When a user requires to login to the remote server, he receives a virtual account by entering a user account. The virtual account and a password are then entered into the remote server using another device. After the remote server successfully authenticates the virtual account and the password, the user is authorized by the remote server to login. As a result, the objective for providing secure user login for remote server is achieved.

### BACKGROUND OF THE INVENTION

1. Field of Invention

The present invention is related to a method for remote server login. In particular, it is related to a method using a second pathway for remote server login.

2. Description of Related Art

As the internet is gaining popularity, a variety of internet services are also giving life to the new from the old. The remote server is accessed by an internet user through a client-side computer. And the services provided by the remote server are, for example, sending/receiving emails, purchasing merchandise, using internet banking, playing online games, and others. Prior to using these aforementioned services, the authentication of user identity through a login procedure is often required for ensuring security during use. When a computer user logs in the remote server, a user account and a password are entered by the computer user at the request at the server-side. The user account which is pre-established and the password are only required to be entered by the user. After server authentication, the service provided by the remote server is then used.

However, the internet today includes groups of internet hackers that implant Trojan horse applications on computers of users. As soon as the user account and the password are entered, the user account and the password that are stored in the register of the computer are intercepted and transmitted to the receiving-end computer designated by the hacker, which leads to the compromise of the user account and the password. Furthermore, it is even more likely that due to the illegal use of the user account by the internet hacker, user welfare is jeopardized and extensive damages to the user are resulted.

### SUMMARY OF THE INVENTION

The objective for the present invention is for providing a method for remote server login. By using a second pathway to login the remote server, the user account and password can avoid being stolen by internet hackers, and the objective for internet security protection is achieved.

The present invention proposes a method for remote server login, which is suitable for remote server login from a first device. The method includes the following procedures: First, a user account is entered. Secondly, the remote server is used for verifying the correctness of the user account. If the user account is correct, a virtual account is then sent back. However, if the user account is incorrect, an error message is sent back. Later, the virtual account and a password are entered using a second device. Furthermore, the virtual account and the password are authenticated by the remote server and the correctness of the virtual account and password are determined. If the virtual account and the password are correct, the access privilege is enabled for the user for the remote server login. However, if the virtual account and/or the password are incorrect, an error message is then sent back.

In a method for a remote server login, according to an embodiment of the present invention, the aforementioned first device, for example, is a computer, personal digital assistant, or a cellular phone.

In a method for a remote server login according to an embodiment of the present invention, the aforementioned second device, for example, is a computer, a personal digital assistant, or a cellular phone.

Because of the setup of adopting the second pathway for remote server login in the present invention; as a result, after the user account is entered, a virtual account is to be obtained during the user login. A different device for accessing the remote server by the virtual account and the password is adopted for achieving the objective of secure remote server login.

It is to be understood that both the foregoing general description and the following detailed description are exemplary, and are intended to provide further explanation of the invention as claimed.

### BRIEF DESCRIPTION OF THE DRAWINGS

The accompanying drawing is included to provide a further understanding of the invention, and is incorporated in and constitute a part of this specification. The drawing illustrates an embodiment of the present invention and, together with the description, serves to explain the principles of the invention.

FIG. 1 is a flow chart schematically illustrating a method for remote server login, according to an embodiment of the present invention.

### DESCRIPTION OF THE PREFERRED EMBODIMENTS

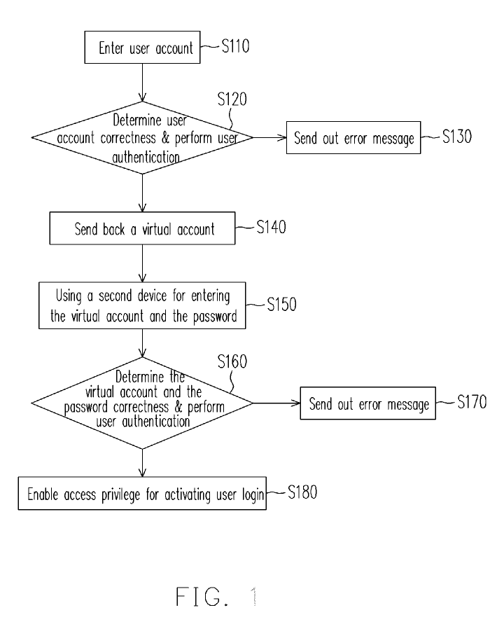

FIG. 1 is a flow chart of a method for remote server login, according to an embodiment of the present invention. Referring to FIG. 1, a user account is entered by the user to obtain a virtual account. Then, the virtual account and a password are entered into a remote server through a second pathway to provide the access to the remote server for authentication and enabling of the access privilege for the user.

First, the user selects a first device to access the remote server. And prior to the remote server login, the user account is entered (step S110), wherein the first device is, for example, a computer with internet access, a personal digital assistant, or a cellular phone, but is not limited hereto. A user can make changes to the structure of the first device without departing from the spirit and scope of the present embodiment by adopting various modifications and variations of the first device.

Furthermore, the remote server is to authenticate the user account entered by the user for determining the correctness of the user account (step S120). If the user account is incorrect, an error message is sent for reminding the user to reenter the user account (step S130). However, if the user account is correct, the virtual account is then sent back through the internet to the aforementioned first device (step S140).

Later, the user selects a second device for entering the virtual account and the password that is pre-established into the remote server (step S150). Wherein, the second device is, for example, a computer with internet access, a personal digital assistant, or a cellular phone, but is not limited hereto.

Later, the remote server is to re-authenticate the virtual account and the password for determining the correctness of the virtual account and the password (step S160). If the virtual account and/or the password are incorrect, an error message is sent to remind the user to reenter the virtual account and the password (step S170). However, if the virtual account and password are correct, the access privilege of the user is enabled (step S180), and the user is able to use the services provided from the remote server on the first device under user operation.

In the aforementioned embodiment, if the user does not carry the second device in his possession, the first device is then used for launching a new window to access the remote server, entering the virtual account and the password in the window, and performing the authentication procedure for remote server login.

In addition, the aforementioned webpage for providing user login is disposed in the homepage of the remote server; therefore, all of the included procedures for authentication and login are processed using the same server. On the other hand, in another embodiment of the present invention, another method for additionally implementing a login server is adopted for providing support including wireless application protocol (WAP), hypertext markup language (HTML), and other similar services.

However, if the aforementioned method is adopted, when the main server receives the user account at the time that the virtual account is formed, the virtual account is also required to be sent to the login server apart from being sent back to the user. Therefore, the virtual account and the password entered by the user are received by the login server, and then transformed into the user account and the password, which are sent back to the main server to perform authentication.

In summary, a second pathway is adopted in the method for remote server login in the present invention. When the user requires a remote server login, the virtual account is obtained by means of entering the user account. In addition, another device is adopted for entering the virtual account and the password into the remote server. After confirmation of authentication by the remote server, the access privilege for the user is enabled, and the objective for providing secure login of the user at the remote server is achieved.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for remote server login suitable for using a first device to login the remote server, the method for remote server login comprising:
entering a user account;
verifying whether the user account is correct or not by the remote server;
sending back a virtual account if the user account is correct;
sending back an error message if the user account is incorrect;
entering the virtual account and a password using a second device;
authenticating the virtual account and the password by the remote server for determining whether the virtual account and the password are correct or not;
enabling an access privilege for providing remote server login if the virtual account and the password are correct; and
sending back an error message if the virtual account or the password are incorrect.

2. The method for remote server login according to claim 1, wherein the first device is a computer, a personal digital assistant (PDA), or a cellular phone.

3. The method for remote server login according to claim 1, wherein the second device is a computer, a personal digital assistant (PDA), or a cellular phone.
